(19) United States
(12) Patent Application Publication
(10) Pub. No.: US 2024/0345410 A1
(43) Pub. Date: Oct. 17, 2024

(54) CAMERA MODULE

(71) Applicant: SAMSUNG ELECTRO-MECHANICS CO., LTD., Suwon-si (KR)

(72) Inventors: Nam Ki PARK, Suwon-si (KR); Soo Cheol LIM, Suwon-si (KR); Su Kyeong KIM, Suwon-si (KR); Ki Hyun ROH, Suwon-si (KR); Se Hyeun YUN, Suwon-si (KR); Se Houn LEE, Suwon-si (KR)

(73) Assignee: SAMSUNG ELECTRO-MECHANICS CO., LTD., Suwon-si (KR)

(21) Appl. No.: 18/427,161

(22) Filed: Jan. 30, 2024

(30) Foreign Application Priority Data
Apr. 12, 2023 (KR) 10-2023-0048398
May 30, 2023 (KR) 10-2023-0069303

(51) Int. Cl. G02B 27/64

(52) U.S. Cl. CPC G02B 27/646

(57) ABSTRACT

A camera module including a lens module, a carrier accommodating the lens module, a housing accommodating the carrier, and a shaking correction driver including a plurality of magnets disposed on the lens module, a plurality of coils disposed on the housing, and three or more position sensors, wherein the shaking correction driver is configured to form driving force to move the lens module on a plane perpendicular to an optical axis, wherein at least one of the plurality of magnets faces two or more position sensors, and wherein a position sensor facing one of the plurality of magnets is disposed closer to the optical axis than a position sensor facing an other of the plurality of magnets.

### CROSS-REFERENCE TO RELATED APPLICATIONS

This application claims the benefit under 35 USC 119 (a) of Korean Patent Application Nos. 10-2023-0048398 filed on Apr. 12, 2023, and 10-2023-0069303 filed on May 30, 2023, in the Korean Intellectual Property Office, the entire disclosures of which are incorporated herein by reference for all purposes.

### BACKGROUND

### 1. Field

The following description relates to a camera module.

### 2. Description of the Background

A camera module may be employed in a portable electronic device such as a smartphone, a tablet PC, and a laptop computer.

The camera module may have various functions such as an autofocus (AF) function, an optical image stabilization (OIS) function, and a zoom (Zoom) function.

The optical image stabilization (OIS) function may be implemented in a manner of moving a lens module in a direction perpendicular to an optical axis. However, the manner of simply moving the lens module in a direction perpendicular to the optical axis, has a limitation in precisely correcting the shaking when the shaking occurs continuously, such as in video shooting.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens module, a carrier accommodating the lens module, a housing accommodating the carrier, and a shaking correction driver including a plurality of magnets disposed on the lens module, a plurality of coils disposed on the housing, and three or more position sensors, wherein the shaking correction driver is configured to form driving force to move the lens module on a plane perpendicular to an optical axis, wherein at least one of the plurality of magnets may face two or more position sensors, and wherein a position sensor facing one of the plurality of magnets is disposed closer to the optical axis than a position sensor facing an other of the plurality of magnets.

The plurality of position sensors may be disposed on a side surface of the housing, and among the three or more position sensors, a center of the position sensor disposed closer to the optical axis may be disposed on a straight line for connecting the optical axis and the side surface of the housing at the shortest distance.

The plurality of magnets may include one or more polarity regions on one surface facing the coil, and the plurality of coils may be disposed to face the polarity regions of the plurality of magnets, respectively.

The plurality of position sensors may be disposed inside at least some of the plurality of coils.

The plurality of magnets may include a first optical image stabilization (OIS) magnet including at least one of a first polarity region and a second polarity region on one surface facing the coil, and a second OIS magnet including a third polarity region and a fourth polarity region on one surface facing the coil, wherein the first polarity region and the second polarity region may have different areas.

Among the plurality of position sensors, a position sensor facing the first OIS magnet may be disposed to face a polarity region having a larger area among the first polarity region and the second polarity region.

A polarity region having a larger area among the first polarity region and the second polarity region may be disposed closer to the optical axis than other polarity regions.

The first OIS magnet may face one position sensor, and the second OIS magnet may face two position sensors.

The plurality of coils may include a first OIS coil facing the first OIS magnet, and a second OIS coil facing the second OIS magnet, wherein the first OIS coil may include one coil or two or more coils of different sizes.

The camera module may further include a plurality of ball members disposed between the lens module and the carrier, wherein the plurality of ball members may be in one-point contact with the lens module and the carrier, respectively.

The camera module may further include a focus adjustment unit including a magnet disposed on the carrier, and a coil and a position sensor disposed in the housing to face the magnet.

In another general aspect, a camera module includes a lens module, and a shake correction driver configured to move the lens module on a plane perpendicular to the optical axis, wherein the shaking correction driver includes a first sub-driver including a first optical image stabilization (OIS) magnet and a first OIS coil configured to form first axis direction driving force perpendicular to the optical axis, and a position sensor facing the first OIS magnet, and a second sub-driver including a second OIS magnet and a second OIS coil configured to form second axis direction driving force perpendicular to the optical axis and the first axis, and two position sensors facing the second OIS magnet, wherein the first OIS magnet includes at least one of a first polarity region and a second polarity region having different areas on one surface facing the first OIS coil.

A position sensor facing the first OIS magnet may face a polarity region having a larger area among the first polarity region and the second polarity region.

A position sensor facing the first OIS magnet may be disposed closer to the optical axis than a position sensor facing the second OIS magnet.

The first OIS coil and the second OIS coil may be provided in a number corresponding to each polarity region included in the first OIS magnet and the second OIS magnet.

The camera module may further include a carrier for accommodating the lens module, and a plurality of ball members disposed between the lens module and the carrier so that the plurality of ball members may be in one-point contact with the lens module and the carrier, respectively.

In another general aspect, a camera module includes a lens barrel having one or more lenses disposed on an optical axis, a lens holder accommodating the lens barrel, and configured to move in a plane perpendicular to the optical axis, a carrier accommodating the lens holder, and configured to move in the optical axis direction, a shake correction driver configured to move the lens holder in the plane, relative to the carrier, and including a first optical image stabilization (OIS) magnet disposed on the lens holder, a first OIS coil disposed to face the first OIS magnet in a first direction in the plane, a second OIS magnet disposed on the lens holder, a second OIS coil disposed to face the second OIS magnet in a second direction in the plane perpendicular to the first direction, wherein the first OIS magnet has a first polarity region extending in the second direction and facing the first OIS coil, wherein the second OIS magnet has a second polarity region extending in the first direction and facing the second OIS coil, and wherein an area of the first polarity region is greater than an area of the second polarity region.

The first OIS magnet may include a third polarity region extending in the second direction and facing the first OIS coil, and an area of the third polarity region may be less than an area of the first polarity region.

The camera module may further include a first OIS position sensor disposed in the first OIS coil configured to detect a position of the first OIS magnet, and two or more second OIS position sensors disposed in the second OIS coil configured to detect a position of the second OIS magnet, wherein the first OIS position sensor may be disposed closer to the optical axis than the second OIS position sensor.

Other features and aspects will be apparent from the following detailed description, the drawings, and the claims.

### BRIEF DESCRIPTION OF DRAWINGS

FIG. 1 is a perspective view of a camera module according to an example embodiment of the present disclosure.

FIG. 2 is a schematic exploded perspective view of a camera module according to an example embodiment of the present disclosure.

FIG. 3 is a partially exploded perspective view of a focus adjustment unit according to an example embodiment of the present disclosure.

FIG. 4 is a partially exploded perspective view of a shake correction unit according to an example embodiment of the present disclosure.

FIG. 5A is a cross-sectional view taken along line I-I′ of FIG. 1, and FIG. 5B is a cross-sectional view taken along line II-II′ of FIG. 1.

FIG. 6 is a plan view illustrating an arrangement form of a first driver and a second driver according to an example embodiment of the present disclosure.

FIGS. 7 to 9 are views illustrating a second driver according to example embodiments of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

Furthermore, in this specification, an optical axis direction may refer to a direction extending up and down the optical axis of a lens module or a direction in parallel with the optical axis, a first axis direction may refer to a direction perpendicular to the optical axis direction, and a second axis direction may refer to a direction perpendicular to both the optical axis direction and the first axis direction.

An aspect of the present disclosure is to improve the optical image stabilization (OIS) performance of a small camera module adopted in a portable electronic device.

A camera module according to an example embodiment of the present disclosure may precisely correct shaking.

The present disclosure relates to a camera module 1 mounted on a portable electronic device. The portable electronic device may be a smart phone, a mobile communication terminal, a tablet PC, a laptop computer, and the like.

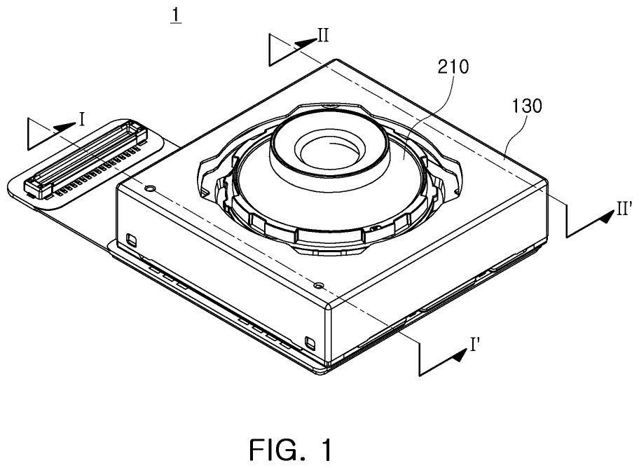

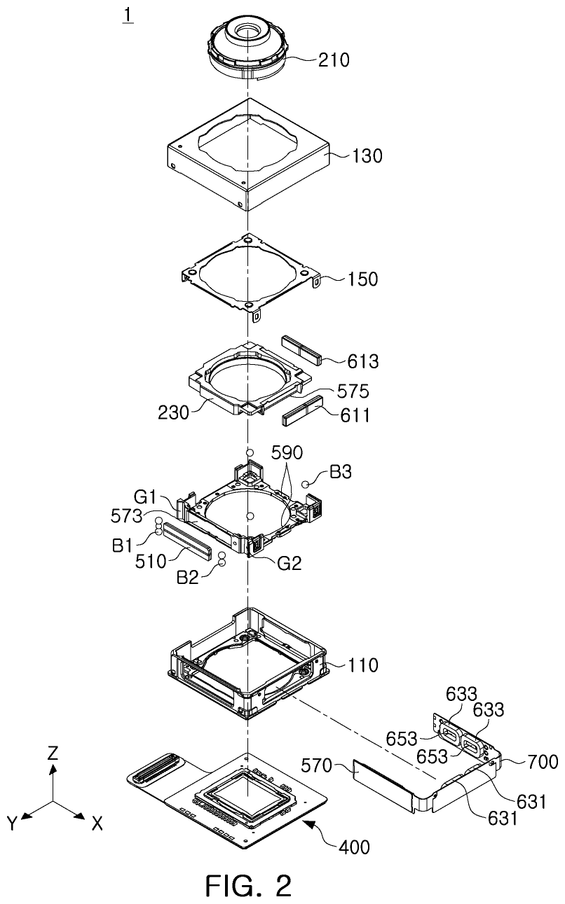

FIG. 1 is a perspective view of a camera module according to an example embodiment of the present disclosure, and FIG. 2 is a schematic exploded perspective view of a camera module according to an example embodiment of the present disclosure.

Referring to FIGS. 1 and 2, a camera module 1 according to an example embodiment of the present disclosure may include a housing 110, a lens module 200 disposed in the housing 110, a carrier 300, and an image sensor module 400.

For example, the lens module 200 may be accommodated in the carrier 300, and the carrier 300 may be accommodated in the housing 110. The image sensor module 400 may be disposed on the bottom of the housing 110.

Furthermore, the camera module 1 may include a case 130 coupled to the housing 110. The case 130 may be coupled to housing 110 to cover the housing 110.

According to an example embodiment of the present disclosure, the housing 110 may be a fixed body. Accordingly, the case 130 and the image sensor module 400 that are fixedly coupled to the housing 110 may also be fixed bodies.

Meanwhile, the lens module 200 and the carrier 300 accommodated in the housing 110 may be moving bodies. The lens module 200 and the carrier 300 may be moved relatively with respect to the housing 110.

For example, the carrier 300 may be moved relatively with respect to the housing 110 in an optical axis (Z-axis) direction. Since the lens module 200 is accommodated in the carrier 300, the lens module 200 may be moved relatively with respect to the housing 110 along with the carrier 300 in the optical axis (Z-axis) direction.

Furthermore, the lens module 200 may be moved relatively with respect to the carrier 300 and the housing 110 on a plane (X-Y plane) perpendicular to the optical axis (Z-axis). In detail, the lens module 200 may be moved in a first axis (X-axis) direction and a second axis (Y-axis) direction, perpendicular to the optical axis (Z-axis) on a plane (X-Y plane), perpendicular to the optical axis (Z-axis), and may also be rotated using the optical axis (Z-axis) as a rotation axis. The lens module 200 may include a lens barrel 210 and a lens holder 230.

The lens barrel 210 may accommodate at least one lens for capturing an image of a subject. When a plurality of lenses are accommodated in the lens barrel 210, the plurality of lenses may be arranged along the optical axis (Z-axis).

The lens barrel 210 may be accommodated in the lens holder 230. For example, the lens barrel 210 may be coupled to the lens holder 230 through an adhesive or the like. Furthermore, a portion of a second driver 600 to be described below may be disposed in the lens holder 230.

The image sensor module 400 may include an image sensor and a sensor substrate on which the image sensor is disposed.

The image sensor may convert light incident through the lens module 200 into an electrical signal. For example, the image sensor may be a charge coupled device (CCD) or a complementary metal-oxide semiconductor (CMOS). The electrical signal converted by the image sensor may be output as an image or a video through a display unit of a portable electronic device equipped with the camera module 1.

The sensor substrate may be a printed circuit board, and the image sensor may be electrically connected to the sensor substrate.

The image sensor module 400 may further include an infrared filter disposed between the lens module 200 and the image sensor. The infrared filter may serve to block light in an infrared region among the light incident through the lens module 200.

The camera module 1 according to an example embodiment of the present disclosure may have a focus adjustment function, and the focus adjustment function may be implemented by moving the carrier 300 in the optical axis (Z-axis) direction.

Since the lens module 200 is accommodated in the carrier 300, the lens module 200 may be moved in the optical axis (Z-axis) direction along with the carrier 300. In this process, a distance in the optical axis (Z-axis) direction between the lens module 200 and the image sensor module 400 may be changed to adjust a focus of the camera module 1.

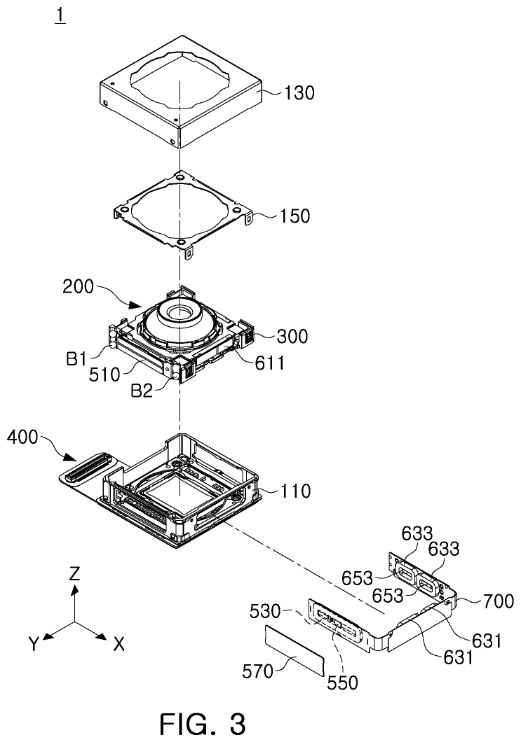

FIG. 3 is a partially exploded perspective view of a focus adjustment unit according to an example embodiment of the present disclosure.

Referring to FIG. 3, the focus adjustment unit may include a carrier 300 moved in the optical axis (Z-axis) direction and a first driver 500 (or a focus adjustment driver) for generating driving force for moving the carrier 300 in the optical axis (Z-axis) direction.

The carrier 300 may be accommodated in the housing 110 and may be moved relatively with respect to the housing 110 in the optical axis (Z-axis) direction by the driving force generated by the first driver 500.

The first driver 500 may include a first magnet 510 and a first coil 530.

The first magnet 510 and the first coil 530 may be separately disposed in the housing 110 and the carrier 300. For example, the first magnet 510 may be disposed in the carrier 300, and the first coil 530 may be disposed in the housing 110. Accordingly, the first magnet 510 may be a moving member moved in the optical axis (Z-axis) direction along with the carrier 300, and the first coil 530 may become a fixed member fixed to the housing 110. However, an example embodiment in which the positions of the first magnet 510 and the first coil 530 are changed from each other is also possible.

The first magnet 510 and the first coil 530 may be disposed to face each other to generate driving force. For example, the first magnet 510 may be disposed on a side surface of the carrier 300, and the first coil 530 may be disposed on a side surface of the housing 110 facing the side surface of the carrier 300 in which the first magnet 510 is disposed. Accordingly, the first magnet 510 and the first coil 530 may face each other in a direction, perpendicular to the optical axis (Z-axis).

Meanwhile, a back yoke 573 may be provided on the side surface of the carrier 300 in which the first magnet 510 is disposed. For example, the back yoke 573 may be inserted into the carrier 300. The back yoke 573 may prevent magnetic flux leakage of the first magnet 510.

The first magnet 510 may have a shape in which an N-pole and an S-pole are magnetized in the optical axis (Z-axis) direction, and a neutral region may be provided between the N-pole and the S-pole.

The first coil 530 may be mounted on a substrate 700, and the substrate 700 on which the first coil 530 is mounted may be disposed on the side surface of the housing 110.

For example, the substrate 700 may be disposed over three side surfaces of the housing 110 in a ‘E’ shape. In this case, the first coil 530 may be mounted on one surface of the substrate 700 disposed on the side surface of the housing 110 facing the side surface of the carrier 300 in which the first magnet 510 is disposed.

When power is applied to the first coil 530, electromagnetic force may be generated between the first magnet 510 and the first coil 530, which may be driving force for moving the carrier 300 in the optical axis (Z-axis) direction. Since the lens module 200 is accommodated in the carrier 300, the lens module 200 may also be moved in the optical axis (Z-axis) direction as the carrier 300 moves in the optical axis (Z-axis) direction.

A first position sensor 550 may be disposed on the substrate 700 along with the first coil 530. For example, the first position sensor 550 may be disposed inside the first coil 530 and may face a neutral region of the first magnet 510 in a direction perpendicular to the optical axis (Z-axis).

The first position sensor 550 may detect a position of the carrier 300 in the optical axis (Z-axis) direction, and may be provided as, for example, a hall sensor.

A stopper 150 may be disposed between the case 130 and the lens module 200. For example, the case 130, the stopper 150, the lens module 200, the carrier 300, and the housing 110 may be sequentially provided in the optical axis (Z-axis) direction.

The stopper 150 may be coupled to the carrier 300 to cover an upper surface of the lens module 200. The stopper 150 may prevent the lens module 200 from being separated to the outside of the carrier 300 when external impacts or the like are applied to the camera module 1.

Furthermore, the stopper 150 may be provided with a buffer member (not illustrated) for absorbing impacts of collisions between the lens module 200 and the case 130 as the carrier 300 moves in the optical axis (Z-axis) direction. For example, the buffer member may be provided on surfaces of the stopper 150, facing the case 130 and the lens module 200, respectively.

A first ball member B1 and a second ball member B2 for guiding a movement of the carrier 300 in the optical axis (Z-axis) direction may be disposed between the carrier 300 and the housing 110.

The first ball member B1 and the second ball member B2 may be spaced apart from each other in a direction perpendicular to the optical axis (Z-axis). For example, the first ball member B1 and the second ball member B2 may be separated between the carrier 300 and the housing 110 in a direction perpendicular to the optical axis (Z-axis), with the first magnet 510 interposed therebetween.

The first ball member B1 and the second ball member B2 may include at least one ball (sphere) moving in a rolling motion. Furthermore, the first ball member B1 and the second ball member B2 may include different numbers of balls (spheres). For example, the first ball member B1 may include three balls (spheres) disposed in the optical axis (Z-axis) direction, and the second ball member B2 may include two balls (spheres) disposed in the optical axis (Z-axis) direction. However, the number of balls (spheres) included in the first ball member B1 and the second ball member B2 is not limited thereto.

The first ball member B1 and the second ball member B2 may be disposed between guide grooves formed in the carrier 300 and the housing 110, respectively.

The carrier 300 may include a first guide groove G1 on one side and a second guide groove G2 on the other side with respect to the first magnet 510. Furthermore, the housing 110 may include a third guide groove G3 facing the first guide groove G1 and a fourth guide groove G4 facing the second guide groove G2. The first ball member B1 may be disposed between the first guide groove G1 and the third guide groove G3, and the second ball member B2 may be disposed between the second guide groove G2 and the fourth guide groove G4.

The first to fourth guide grooves G1 to G4 may all be extended in the optical axis (Z-axis) direction, and accordingly, in a state in which each of the first ball member B1 and the second ball member B2 is disposed therebetween, the first ball member B1 and the second ball member B2 may move in the rolling motion in the optical axis (Z-axis) direction.

According to an embodiment of the present disclosure, the first guide groove G1 and the third guide groove G3 may have a ‘v’ shaped cross-section cut in a direction, perpendicular to the optical axis (Z-axis).

In the first ball member B1, among the three balls (spheres) disposed in the optical axis (Z-axis) direction, at least two balls (spheres) disposed on an outermost side may be in two-point contact with the first guide groove G1 and the third guide groove G3, respectively. Accordingly, the first ball member B1 may function as a main guide that guides the movement of the carrier 300 in the optical axis (Z-axis) direction.

In the second guide groove G2 and the fourth guide groove G4, cross-sectional shapes cut in a direction, perpendicular to the optical axis (Z-axis) may have a ‘v’ shape or a ‘-’ shape. For example, the cross-section of the second guide groove G2 may have a ‘-’ shape, and the cross-section of the fourth guide groove G4 may have a ‘v’ shape.

In the second ball member B2, at least a portion of the two balls (spheres) disposed in the optical axis (Z-axis) direction may be in one-point contact with the second guide groove G2, and may be in two-point contact with the fourth guide groove G4. Accordingly, the second ball member B2 may function as an auxiliary guide for supporting the movement of the carrier 300 in the optical axis (Z-axis) direction.

In an example embodiment of the present disclosure, as long as the first ball member B1 functions as the main guide and the second ball member B2 functions as the auxiliary guide, the second ball member B2 may include a smaller number of balls (spheres) than the first ball member B1.

A first yoke 570 may be disposed in the housing 110. The first yoke 570 may be disposed to cover the substrate 700, for example, to cover a surface opposite to one surface on which the first coil 530 is disposed.

The first yoke 570 may be disposed to face the first magnet 510 with the first coil 530 interposed therebetween and may generate attractive force with the first magnet 510. For example, the first yoke 570 and the first magnet 510 may generate the attractive force in a direction perpendicular to the optical axis (Z-axis), in which the first yoke 570 and the first magnet 510 face each other. Due to the attractive force, the first ball member B1 and the second ball member B2 may maintain contact with the carrier 300 and the housing 110.

The camera module 1 according to an example embodiment of the present disclosure may have a shake correction function, and the shaking correction function may be implemented by moving the lens module 200 in the direction perpendicular to the optical axis (Z-axis), and rotating the lens module 200 with the optical axis (Z-axis) as the rotation axis.

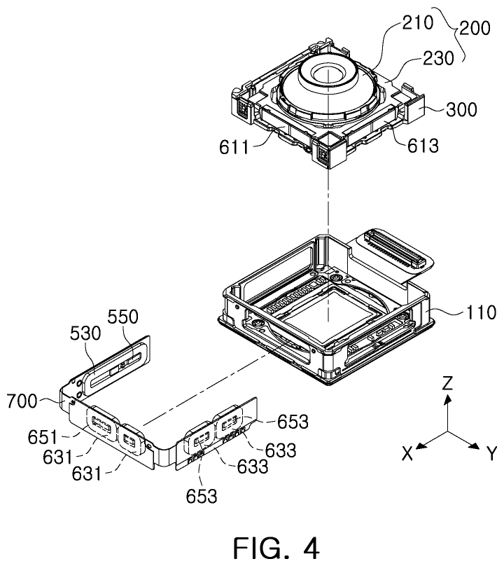

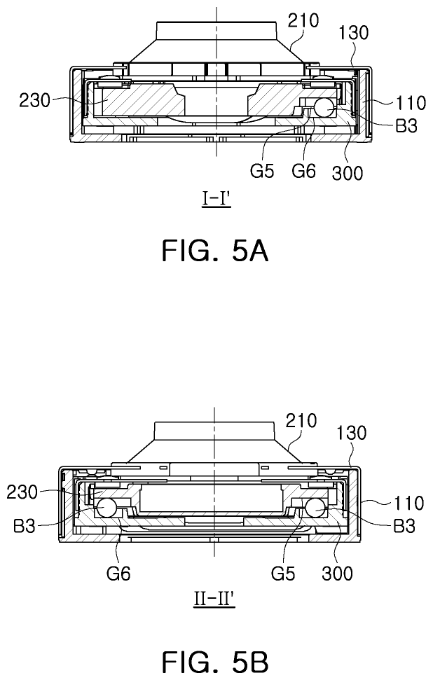

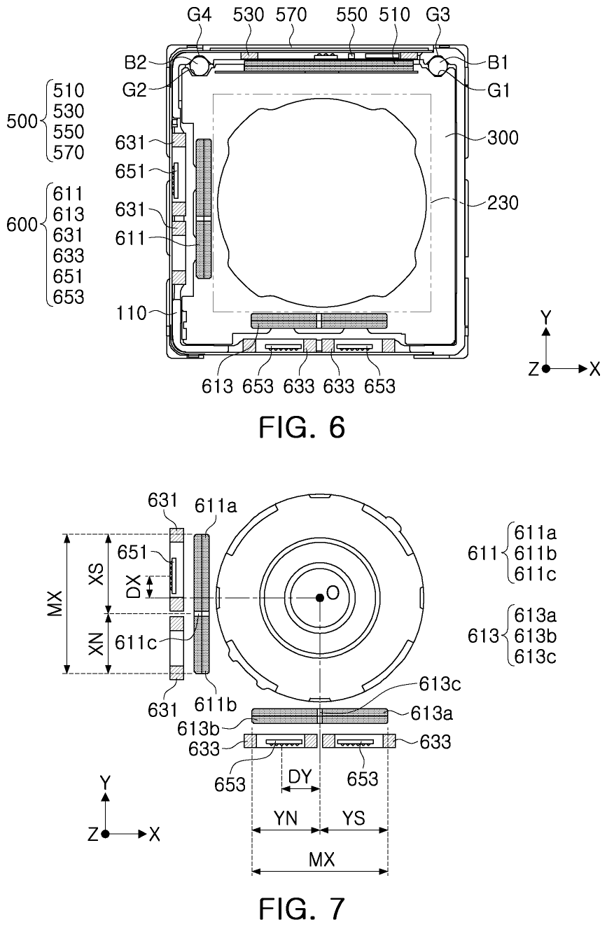

FIG. 4 is a partially exploded perspective view of a shake correction unit according to an example embodiment of the present disclosure, FIG. 5A is a cross-sectional view taken along line I-I′ of FIG. 1, FIG. 5B is a cross-sectional view taken along line II-II′ of FIG. 1, and FIG. 6 is a plan view illustrating an arrangement form of a first driver and a second driver according to an example embodiment of the present disclosure.

Referring to FIG. 4, the shake correction unit may include a lens module 200 moved on a plane (X-Y plane) perpendicular to the optical axis (Z-axis), and a second driver 600 for generating driving force for moving the lens module 200 on the plane (X-Y plane) perpendicular to the optical axis (Z-axis).

The lens module 200 may be accommodated in a carrier 300, and may be moved relatively and rotated on the plane (X-Y plane) perpendicular to the optical axis (Z-axis) with respect to the carrier 300 by driving force generated by the second driver 600.

The second driver 600 may include a second magnet 611 (or a first OIS magnet) and a second coil 631 (or a first OIS coil), and a third magnet 613 (or a second OIS magnet) and a third coil 633 (or a second OIS coil).

The second magnet 611 and the second coil 631, and the third magnet 613 and the third coil 633 may be separately disposed in the housing 110 and the lens module 200, specifically, in the lens holder 230, respectively. For example, the second magnet 611 and the third magnet 613 may be disposed in the lens holder 230, and the second coil 631 and the third coil 633 may be disposed in the housing 110. Accordingly, the second magnet 611 and the third magnet 613 may be moving members moving on a plane (X-Y plane) perpendicular to the optical axis (Z-axis) along with the lens module 200, and the second coil 631 and the third coil 633 may be fixing members fixed to the housing 110. However, an example embodiment in which the positions of the second magnet 611 and the third magnet 613, and the second coil 631 and the third coil 633 are changed from each other is also possible.

The second magnet 611 and the second coil 631, and the third magnet 613 and the third coil 633 may be disposed to face each other to generate driving force. For example, the second magnet 611 and the third magnet 613 may be disposed on different side surfaces of the lens holder 230, respectively, and the second coil 631 and the third coil 633 may be disposed on side surfaces of the housing 110 respectively facing side surfaces of the lens holder 230 in which the second magnet 611 and the third magnet 613 are disposed. Accordingly, the second magnet 611 and the second coil 631, and the third magnet 613 and the third coil 633 may face each other in the direction perpendicular to the optical axis (Z-axis).

Meanwhile, a back yoke 575 may be provided on a side surface of the lens holder 230 in which the second magnet 611 and the third magnet 613 are disposed. For example, the back yoke 575 may be inserted into the lens holder 230. The back yoke 575 may prevent magnetic flux leakage of the second magnet 611 and the third magnet 613.

The second magnet 611 and the third magnet 613 may have one or more polarity regions in a longitudinal direction (e.g., a direction perpendicular to the optical axis (Z-axis)) of each magnet, and a neutral region may be provided between the two or more polarity regions.

Meanwhile, according to an example embodiment of the present disclosure, one of the second magnet 611 and the third magnet 613 may include a polarity region having a different area.

Furthermore, each of the second coil 631 and the third coil 633 may include one or more coils. For example, the second coil 631 and the third coil 633 may include the number of coils corresponding to the number of polarity regions included in one surface of the second magnet 611 and the third magnet 613 facing the coils. When the second coil 631 and the third coil 633 include a plurality of coils, the plurality of coils may be disposed in a longitudinal direction of the second magnet 611 or the third magnet 613 to face the polarity regions of each magnet.

The second coil 631 and the third coil 633 may be mounted on the substrate 700 together with the first coil 530 and disposed on the side surface of the housing 110.

For example, the second coil 631 and the third coil 633 may each be mounted on the remaining two surfaces of a ‘ [symbol] ’ shaped substrate 700 in which the first coil 530 is not disposed. That is, the second magnet 611 and the third magnet 613 may also be disposed on two different surfaces of the lens holder 230 so as not to overlap one surface of the carrier 300 in which the first magnet 510 is disposed.

In an example embodiment, when power is applied to the second coil 631, electromagnetic force may be generated between the second magnet 611 and the second coil 631, which may be driving force for moving the lens module 200 in a first axis (X-axis) direction or a second axis (Y-axis) direction, perpendicular to the optical axis (Z-axis).

Similarly, when power is applied to the third coil 633, electromagnetic force may be generated between the third magnet 613 and the third coil 633, which may be the driving force for moving the lens module 200 in the first axis (X-axis) direction or the second axis (Y-axis) direction, perpendicular to the optical axis (Z-axis).

Furthermore, when the electromagnetic force between the second magnet 611 and the second coil 631 and the electromagnetic force between the third magnet 613 and the third coil 633 occur simultaneously, rotational force for rotating the lens module 200 with the optical axis (Z-axis) as the rotation axis may be generated.

Accordingly, the camera module 1, according to an example embodiment of the present disclosure may be capable of 3-axis shake correction.

A second position sensor 651 and a third position sensor 653 may be disposed on the substrate 700 along with the second coil 631 and the third coil 633. For example, the second position sensor 651 and the third position sensor 653 may be disposed inside at least some of the coils included in the second coil 631 and the third coil 633. In other words, the second position sensor 651 or the third position sensor 653 may or may not be disposed inside the coils included in the second coil 631 and the third coil 633.

The second position sensor 651 and the third position sensor 653 may detect the position of the lens module 200 in directions (X-axis and Y-axis), perpendicular to the optical axis (Z-axis). For example, the second position sensor 651 and the third position sensor 653 may be provided in the form of a hall sensor or a D/IC chip in which the hall sensor is embedded.

Furthermore, in order to detect the rotation of the lens module 200, at least one of the second position sensor 651 and the third position sensor 653 may be provided in plural. For example, the number of second position sensors 651 and third position sensors 653 may be three in total. Referring to FIG. 6, one second position sensor 651 may be provided, and two third position sensors 653 may be provided.

In the lens module 200, specifically, between the lens holder 230 and the carrier 300, a third ball member B3 may be disposed to guide a movement of the lens module 200 on a plane (X-Y plane) perpendicular to the optical axis (Z-axis).

The third ball member B3 may include a plurality of balls (spheres) moving in a rolling motion, and may include at least three balls (spheres). For example, the third ball member B3 may include three balls (spheres), and the three balls (spheres) may be disposed at three edges adjacent to the second driver 600, respectively.

The third ball member B3 may be disposed between the guide grooves formed in the lens holder 230 and the carrier 300, respectively.

The lens holder 230 may include a fifth guide groove G5 at three edges of one surface facing the carrier 300. Furthermore, the carrier 300 may include a sixth guide groove G6 at three edges of one surface facing the lens holder 230. The third ball member B3 may be disposed between the fifth guide groove G5 and the sixth guide groove G6.

According to an example embodiment of the present disclosure, in the fifth guide groove G5 and the sixth guide groove G6, a cross-sectional shape cut in the optical axis (Z-axis) direction as illustrated in FIGS. 5A and 5B may be a ‘-’ shape, i.e., a flat shape. Accordingly, the third ball member B3 may be in one-point contact the fifth guide groove G5 and the sixth guide groove G6, respectively.

Furthermore, sizes of the fifth guide groove G5 and the sixth guide groove G6 may be larger than a diameter of the third ball member B3. Here, the sizes of the fifth guide groove G5 and the sixth guide groove G6 may refer to a length in the first axis (X-axis) direction and the second axis (Y-axis) direction.

Accordingly, the third ball member B3 may freely move in the rolling motion without being restricted to a specific direction, in a state in which the third ball member B3 is disposed between the fifth guide groove G5 and the sixth guide groove G6.

The third ball member B3 may guide a movement of the lens module 200 on a plane (X-Y plane) perpendicular to the optical axis (Z-axis), while moving in the rolling motion, in a state in which third ball member B3 is disposed between the fifth guide groove G5 and the sixth guide groove G6. Furthermore, the third ball member B3 may also serve to maintain a gap between the lens module 200 and the carrier 300, more specifically, a gap in the optical axis (Z-axis) direction.

A pulling yoke may be disposed in the carrier 300. For example, the pulling yoke may be provided as a separate member, and may be disposed in the carrier 300 or may be inserted into the carrier 300 and formed integrally with the carrier 300.

The pulling yoke 590 may be disposed to face the second magnet 611 and the third magnet 613, respectively, and may generate attractive force in a direction facing the second magnet 611 and the third magnet 613. For example, the pulling yoke 590 may generate the attractive force in the direction of the optical axis (Z-axis) facing the second magnet 611 and the third magnet 613. Due to the attractive force, the third ball member B3 may maintain contact with the lens holder 230 and the carrier 300.

As described above, the camera module 1 according to an example embodiment of the present disclosure may be capable of 3-axis shake correction by the second driver 600, and may have the following structure for precise correction.

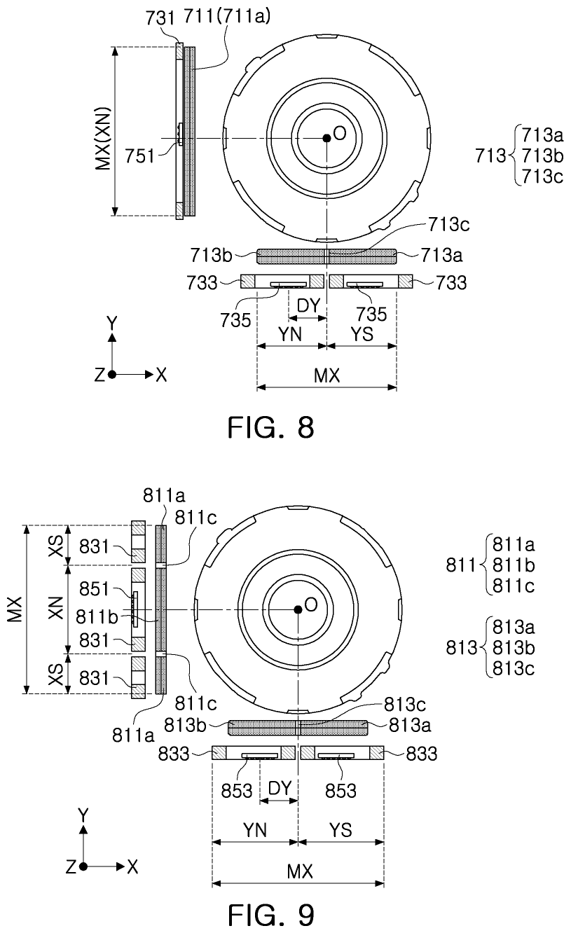

FIGS. 7 to 9 are views illustrating a second driver according to example embodiments of the present disclosure.

Referring to FIGS. 7 to 9, a second driver 600 may include a first sub-driver and a second sub-driver.

The first sub-driver may include a second magnet 611 and a second coil 631, and the second magnet 611 and the second coil 631 may generate driving force in the first axis (X-axis) direction. Furthermore, the second sub-driver may include a third magnet 613 and a third coil 633, and the third magnet 613 and the third coil 633 may generate driving force in the second axis (Y-axis) direction.

However, a direction of the driving force generated by the first sub-driver and the second sub-driver may be changed, and even when changed, the following description may be equally applied.

The first sub-driver and the second sub-driver may include a position sensor for sensing a position of the lens module 200. For example, the first sub-driver may include a second position sensor 651 for sensing a first axis (X-axis) position of the lens module 200, and the second sub-driver may include a third position sensor 653 for sensing a second axis (Y-axis) position of the lens module 200.

The second position sensor 651 and the third position sensor 653 may be disposed to face polarity regions of the second magnet 611 and the third magnet 613.

According to an example embodiment of the present disclosure, the second position sensor 651 may be disposed closer to a lens center O (or the optical axis (Z-axis)) than the third position sensor 653.

In order to make a difference in a distance between the second position sensor 651 and the third position sensor 653 with respect to the lens center O, the second magnet 611 may include polarity regions of different size areas. Specifically, the second magnet 611 may have one or more polarity regions magnetized to an N-pole or an S-pole on one surface facing the second coil 631 in the longitudinal direction, and areas of different polarity regions may be different sizes from each other.

Referring to FIG. 7, the second magnet 611 may include a first polarity region 611a whose surface facing the second coil 631 is magnetized to the S-pole or the N-pole on one surface facing the second coil 631 (an opposite surface thereto is magnetized to the N-pole or the S-pole), and a second polarity region 611b whose surface facing the second coil 631 is magnetized to the N-pole or the S-pole (an opposite surface thereto is magnetized to the S-pole or the N-pole). Furthermore, the second magnet 611 may include a neutral region 611c between the first polarity region 611a and the second polarity region 611b.

Areas of the first polarity region 611a and the second polarity region 611b may be different from each other, and the area of the first polarity region 611a may be larger than the area of the second polarity region 611b. For example, a length XS of the first polarity region 611a may be longer than a length XN of the second polarity region 611b. On the other hand, as the second magnet 611 has an asymmetric structure in which the areas of the first polarity region 611a and the second polarity region 611b are different from each other, a neutral region 611c provided therebetween may be disposed to be biased to one side with respect to the lens center O, the first polarity region 611a having a relatively large area may be disposed on an extension line extending in the first axis (X-axis) direction while passing through the lens center O.

The second coil 631 may include two coils, and the two coils may face the first polarity region 611a and the second polarity region 611b, respectively. Since the first polarity region 611a and the second polarity region 611b have different areas, sizes of the coils facing each polarity region may also be different from each other.

One second position sensor 651 may be provided, and may be disposed inside the coil facing the first polarity region 611a, that is, a polarity region having a large area, among the two coils included in the second coil 631.

Meanwhile, the third magnet 613 may include a third polarity region 613a, whose surface facing the third coil 633 is magnetized to an S-pole or an N-pole on one surface facing the third coil 633 (an opposite surface thereto is magnetized to the N-pole or the S-pole), and a fourth polarity region 613b whose surface facing the third coil 633 is magnetized to the N-pole or the S-pole (an opposite surface thereto is magnetized to the S-pole or the N-pole). Furthermore, a neutral region 613c may be included between the third polarity region 613a and the fourth polarity region 613b.

Areas of the third polarity region 613a and the fourth polarity region 613b of the third magnet 613 may be substantially the same size as each other. For example, a length YS of the third polarity region 613a may be identical to a length YN of the fourth polarity region 613b. Accordingly, the neutral region 613c may be disposed on an extension line extending in the second axis (Y-axis) direction while passing through the lens center O.

The third coil 633 may include two coils, and the two coils may face the third polarity region 613a and the fourth polarity region 613b, respectively.

Two third position sensors 653 may be provided, and may be disposed inside the two coils included in the third coil 633, respectively.

According to an embodiment illustrated in FIG. 7, a distance DX between the lens center O and a center of the second position sensor 651 may be shorter than a distance DY between the lens center O and a center of the third position sensor 653.

As the second position sensor 651 is disposed closer to the lens center O, the second position sensor 651 may improve errors of a first axis (X-axis) position of the lens module 200, specifically, a first axis (X-axis) position of the lens module 200 detected during an occurrence of rotation.

For example, the distance DX between the lens center O and the center of the second position sensor 651 may satisfy the following Equation 1.

0≤DX<MX*0.2 Equation 1

Where MX is a length of the second magnet 611.

Furthermore, when the third position sensor 653 is separated from the lens center O by a certain distance or more, the time required for shaking correction may be reduced.

For example, the distance DY between the lens center O and the center of the third position sensor 653 may satisfy the following Equation 2.

DY>MY*0.2 Equation 2

Where MY is a length of the third magnet 613.

Referring to FIG. 8, a second magnet 711 may include a first polarity region 711a whose surface facing a second coil 731 is magnetized to an N-pole or an S-pole on one surface facing the second coil 731 (an opposite surface thereto is magnetized to an S-pole or an N-pole). That is, the second magnet 711 may include only one polarity region on a surface facing the second coil 731, and a length MX of the second magnet 711 may be identical to a length XN of the first polarity region 711a. Similarly, even in the case of an embodiment in which the second magnet 711 includes only the first polarity region 711a on the surface facing the second coil 731, the areas of the first polarity region 711a and the second polarity region (not shown) may be different from each other, and may correspond to an asymmetric structure.

Since the second magnet 711 includes only the first polarity region 711a, the second coil 731 may include one coil facing the first polarity region 711a.

Furthermore, the second position sensor 751 may be disposed inside one coil.

The second sub-driver (third magnet 713 (third polarity region 713a, fourth polarity region 713b, neutral region 713c), third coil 733, and third position sensor 735) is the same as an example embodiment illustrated in FIG. 7 second sub-driver (third magnet 613 (third polarity region 613a, fourth polarity region 613b, neutral region 613c), third coil 633, and third position sensor 653), and a description thereof will be omitted.

According to an example embodiment illustrated in FIG. 8, the center of the second position sensor 751 may be disposed on an extension line extending in the first axis (X-axis) direction while passing through the lens center O, or on a straight line for connecting the optical axis (Z-axis) and a side surface of the housing 110 at the shortest distance.

Referring to FIG. 9, the second magnet 811 may include two first polarity regions 811a whose surface facing a second coil 831 is magnetized to an S-pole or an N-pole on one surface facing the second coil 831 (an opposite side thereto is magnetized to the N-pole or the N-pole), and a second polarity region 811b whose surface facing the second coil 831 is magnetized to the N-pole or the S-pole (an opposite surface thereto is magnetized to the S-pole or the N-pole). The second polarity region 811b may be disposed between the two first polarity regions 811a. Furthermore, the second magnet 811 may include a neutral region 811c between the first polarity region 811a and the second polarity region 811b and between the second polarity region 811b and the first polarity region 811a, respectively.

Areas of the first polarity region 811a and the second polarity region 811b may be different from each other, and in an example embodiment of FIG. 9, the size of the area of the second polarity region 811b may be larger than the size of the area of the first polarity region 811a. For example, a length XN of the second polarity region 811b may be longer than a length XS of the first polarity region 811a.

The second coil 831 may include three coils, and the three coils may face the first polarity region 811a, the second polarity region 811b, and another first polarity region 811a, respectively. Since the first polarity region 811a and the second polarity region 811b have different areas, the sizes of the coils facing each polarity region may also be different from each other.

One second position sensor 851 may be provided, and may be disposed inside the coil facing the second polarity region 811b, that is, a polarity region having a large area, among the three coils included in the second coil 831.

The second sub-driver (third magnet 813 (third polarity region 813a, fourth polarity region 813b, neutral region 813c), third coil 833, and third position sensor 853) is the same as an example embodiment illustrated in FIG. 7 second sub-driver (third magnet 613 (third polarity region 613a, fourth polarity region 613b, neutral region 613c), third coil 633, and third position sensor 653), and a description thereof will be omitted.

According to an example embodiment illustrated in FIG. 9, a center of the second position sensor 851 may be disposed on an extension line extending in the first axis (X-axis) direction while passing through the lens center O or on a straight line for connecting the optical axis (Z-axis) and the side surface of the housing 110 at the shortest distance.

According to embodiments of the present disclosure, the extension line extending in the first axis (X-axis) direction while passing through the lens center O may pass through a polarity region having a large area among the polarity regions of the second magnets 611, 711, and 811, and a coil disposed to face the polarity region. Accordingly, when the second position sensors 651, 751, and 851 are disposed inside the coil facing the large polarity regions of the second magnets 611, 711, and 811, a distance DX between the lens center O and centers of the second position sensors 651, 751, and 851 may be minimized.

As disclosed above, according to an example embodiment of the present disclosure, the camera module 1 has a three-axis vibration correction function and may more accurately correct vibrations. Furthermore, since a ball member is provided in one stage to guide shaking correction, a thickness of the camera module 1 in the optical axis (Z-axis) direction may be slimmed.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens module;
a carrier accommodating the lens module;
a housing accommodating the carrier; and
a shaking correction driver comprising a plurality of magnets disposed on the lens module, a plurality of coils disposed on the housing, and three or more position sensors, wherein the shaking correction driver is configured to form driving force to move the lens module on a plane perpendicular to an optical axis,
wherein at least one of the plurality of magnets faces two or more position sensors, and
wherein a position sensor facing one of the plurality of magnets is disposed closer to the optical axis than a position sensor facing an other of the plurality of magnets.

2. The camera module according to claim 1, wherein the plurality of position sensors are disposed on a side surface of the housing, and
wherein among the three or more position sensors, a center of the position sensor disposed closer to the optical axis is disposed on a straight line for connecting the optical axis and the side surface of the housing at the shortest distance.

3. The camera module according to claim 1, wherein the plurality of magnets include one or more polarity regions on one surface facing the coil, and
wherein the plurality of coils are disposed to face the polarity regions of the plurality of magnets, respectively.

4. The camera module according to claim 3, wherein the plurality of position sensors are disposed inside at least some of the plurality of coils.

5. The camera module according to claim 4, wherein the plurality of magnets comprises:
a first optical image stabilization (OIS) magnet including at least one of a first polarity region and a second polarity region on one surface facing the coil; and
a second OIS magnet including a third polarity region and a fourth polarity region on one surface facing the coil,
wherein the first polarity region and the second polarity region have different areas.

6. The camera module according to claim 5, wherein among the plurality of position sensors, a position sensor facing the first OIS magnet is disposed to face a polarity region having a larger area among the first polarity region and the second polarity region.

7. The camera module according to claim 5, wherein a polarity region having a larger area among the first polarity region and the second polarity region is disposed closer to the optical axis than other polarity regions.

8. The camera module according to claim 5, wherein the first OIS magnet faces one position sensor, and the second OIS magnet faces two position sensors.

9. The camera module according to claim 5, wherein the plurality of coils comprise:
a first OIS coil facing the first OIS magnet; and
a second OIS coil facing the second OIS magnet,
wherein the first OIS coil comprises one coil or two or more coils of different sizes.

10. The camera module according to claim 1, further comprising: a plurality of ball members disposed between the lens module and the carrier,
wherein the plurality of ball members are in one-point contact with the lens module and the carrier, respectively.

11. The camera module according to claim 1, further comprising: a focus adjustment unit including a magnet disposed on the carrier, and a coil and a position sensor disposed in the housing to face the magnet.

12. A camera module comprising:
a lens module; and
a shake correction driver configured to move the lens module on a plane perpendicular to the optical axis,
wherein the shaking correction driver comprises:
a first sub-driver comprising a first optical image stabilization (OIS) magnet and a first OIS coil configured to form first axis direction driving force perpendicular to the optical axis, and a position sensor facing the first OIS magnet; and
a second sub-driver comprising a second OIS magnet and a second OIS coil configured to form second axis direction driving force perpendicular to the optical axis and the first axis, and two position sensors facing the second OIS magnet,
wherein the first OIS magnet comprises at least one of a first polarity region and a second polarity region having different areas on one surface facing the first OIS coil.

13. The camera module according to claim 12, wherein a position sensor facing the first OIS magnet faces a polarity region having a larger area among the first polarity region and the second polarity region.

14. The camera module according to claim 12, wherein a position sensor facing the first OIS magnet is disposed closer to the optical axis than a position sensor facing the second OIS magnet.

15. The camera module according to claim 12, wherein the first OIS coil and the second OIS coil are provided in a number corresponding to each polarity region included in the first OIS magnet and the second OIS magnet.

16. The camera module according to claim 12, further comprising:
a carrier for accommodating the lens module; and
a plurality of ball members disposed between the lens module and the carrier so that the plurality of ball members are in one-point contact with the lens module and the carrier, respectively.

17. A camera module comprising:
a lens barrel comprising one or more lenses disposed on an optical axis;
a lens holder accommodating the lens barrel, and configured to move in a plane perpendicular to the optical axis;
a carrier accommodating the lens holder, and configured to move in the optical axis direction;
a shake correction driver configured to move the lens holder in the plane, relative to the carrier, and comprising:
a first optical image stabilization (OIS) magnet disposed on the lens holder;
a first OIS coil disposed to face the first OIS magnet in a first direction in the plane;
a second OIS magnet disposed on the lens holder;
a second OIS coil disposed to face the second OIS magnet in a second direction in the plane perpendicular to the first direction,
wherein the first OIS magnet comprises a first polarity region extending in the second direction and facing the first OIS coil,
wherein the second OIS magnet comprises a second polarity region extending in the first direction and facing the second OIS coil, and
wherein an area of the first polarity region is greater than an area of the second polarity region.

18. The camera module according to claim 17, wherein the first OIS magnet comprises a third polarity region extending in the second direction and facing the first OIS coil, and an area of the third polarity region is less than an area of the first polarity region.

19. The camera module according to claim 17, further comprising:
a first OIS position sensor disposed in the first OIS coil configured to detect a position of the first OIS magnet; and
two or more second OIS position sensors disposed in the second OIS coil configured to detect a position of the second OIS magnet,
wherein the first OIS position sensor is disposed closer to the optical axis than the second OIS position sensor.
